(19) United States
(12) Patent Application Publication
(10) Pub. No.: US 2016/0036999 A1
(43) Pub. Date: Feb. 4, 2016

(54) System, Method, and Apparatus for Free Printing

(71) Applicant: Ken Kaye, Saint Petersburg, FL (US)

(72) Inventor: Ken Kaye, Saint Petersburg, FL (US)

(21) Appl. No.: 14/813,714

(22) Filed: Jul. 30, 2015

Related U.S. Application Data
(60) Provisional application No. 62/031,188, filed on Jul. 31, 2014.

(51) Int. Cl. H04N 1/00; G06Q 30/02; G06F 3/12

(52) U.S. Cl. CPC H04N 1/00188; H04N 1/00129; H04N 1/00307; H04N 1/00143; H04N 1/00482; G06F 3/1204; G06F 3/1292; G06Q 30/0253; G06Q 30/0273; G06Q 30/0268; H04N 2201/0094

(57) ABSTRACT

Print/fax/scan/copy kiosk located at various points of service such as convenience stores provides services to authorized users, including printing of documents, scanning of documents, copying, and sending faxes. At least some quantity of such services is provided at no cost as a service to the users and to attract the users to the point(s) of service, being subsidized by advertisements that are displayed at the kiosk. Each user must be authorized to use the service and, in some embodiments, the user is provided with a predetermined amount of free usage per period of time such as five free print pages per week, twenty free print/copy pages per month, 50 free scan pages per month, etc. In some embodiments, after exceeding the predetermined free usage per period, the user is provided with further service at a fee, for example, five cents per page printed, etc.

### CROSS-REFERENCE TO RELATED APPLICATION

This application claims the benefit of U.S. provisional application No. 62/031,188 filed on Jul. 31, 2015, the disclosure of which is incorporated by reference.

### FIELD

This invention relates to the field of printing, scanning, faxing, and copying; and more particularly to a system for providing such service for free.

### BACKGROUND

Today, paper remains an important part of everyday life from airline boarding passes to legal documents.

At the same time, the evolution of printing (as well as copying, faxing, and scanning) has gone from high volume central printers, to low cost individual printers, and in some situations, back to high volume printers in print shops. The industry has shaped and reshaped constantly over the years with specialized print shops losing business to home printers, then copy shops replacing such.

The home printer business has become very large. In many situations, the entry cost for such printers is very low, subsidized by the fact that the purchaser will soon need to buy toner or ink cartridges, which carry a very high profit margin.

Many have home printers to print small documents, airline boarding passes, etc. Most of these printers are connected to personal computers in the home. As technology shifts even more personally where each member of a household has their own personal device, many homes are finding that there is less of a need for a single stationary computer, especially with tablets and smartphones. For many tasks, no printing is needed, as these devices often travel with the individual. For example, most airlines have applications that allow for displaying of their boarding pass on a smartphone, eliminating the need to print a boarding pass.

Being such, there becomes less of a need or desire to own individual or household printers, especially considering the cost, maintenance, supplies (paper, ink, toner), power consumption, and space consumption. Unfortunately, there seems to always be a need at some time to print something, whether it be a document, an event ticket, an invitation, a business presentation, etc.

Some printing needs are met by specialized copy/print services, typically provided by a small store in a strip mall. The user brings a file that needs to be printed, pays for the services, and later receives printed copies of the file. This is especially useful when printing large quantities of paper as is done, for example, when making a presentation, especially when traveling to remote locations. This also provides specialized printing that is not always available to employees of small firms, such as color printing, stapling, etc. In a similar way, photographs are printed for a fee by specialized printers, typically at drugstores. Again, these print scenarios are somewhat specialized and are all on a fee basis. In addition, these services are not always performed at locations that are typically frequented by the users, therefore requiring the users to make special trips that often require extra time and travel expense (e.g. fuel).

Getting back to why many people had/have a home printer—there is often a need to print a few pages, especially when many companies are moving to become paperless. For example, some insurance companies are sending their policies in email as locked files, without sending such on paper by mail. If the recipient wants a paper copy, they need access to a printer maybe a few times per year. This does not warrant buying and owning a printer full time, yet it may be important to have access to a printer on certain occasions.

Often, such in-home devices fail when they are most needed, running out of paper, running out of ink/toner, or malfunctioning. At a cost that is often less than $200, it is not cost-effective to have a service call to one's home. Likewise, at a weight of maybe 50 pounds, it is often not cost-effective to ship the device to a repair facility. When these devices malfunction, the user has several problems. They still need to print/fax/scan/copy whatever they were just about to print/fax/scan/copy. They need to dispose of the failed device and they need a replacement device. Often, the replacement device uses different toner/ink cartridges and, therefore, the old device is disposed along with a partial toner/ink cartridge.

Similar scenarios occur with sending faxes, making copies, and scanning paper documents. There are some higher-end, more costly printers that also scan documents, make copies, and send faxes, but again, these devices have costs, use power, take up space, and require maintenance, supplies, etc.

In summary, there are many reasons why the proliferation of individual printers is becoming less functional in today's society, not to mention the ecological effect of all these devices being powered (parasitic power consumption), countless partially used toner cartridges, recycling issues, etc.

To further the above, individual owners of such devices must learn enough to be proficient in installation, maintenance, configuration, minor repairs, troubleshooting, adding supplies (paper, ink, and toner), etc.

Further, many corporate printers/scanners/fax systems include a display for presenting a user interface and/or for inputting data (e.g., number of copies to make), but this display is not used to present advertisement, for example, during a medium-length copy job in which the operator is likely to be standing at the corporate printers/scanners/fax system while waiting for the copy job to complete.

What is needed is a way to print/scan/fax/copy at convenient locations with little or no cost.

### SUMMARY

In one embodiment, print/fax/scan/copy kiosks are located at various points of service such as convenience stores, hotel lobbies, airports, etc. Each print/fax/scan/copy kiosk provides services to authorized users, including printing of documents, scanning of documents, copying, and sending faxes. At least some quantity of such services is provided at no cost as a service to the users and to attract the users to the point(s) of service, being subsidized by advertisements that are displayed at the kiosk. Each user must be authorized to use the service and, in some embodiments, the user is provided with a predetermined amount of free usage per period of time such as five free print pages per week, twenty free print/copy pages per month, 50 free scan pages per month, etc. In some embodiments, after exceeding the predetermined free usage per period, the user is provided with further service at a fee, for example, five cents per page printed, etc.

In some embodiments, the point of service owns the print/fax/scan/copy kiosks while in other embodiments, another organization owns the print/fax/scan/copy kiosks and there is a revenue sharing agreement to compensate the point of service for the real estate, for power usage, and for assistance such as refilling paper, refilling toner/ink, etc.

In some embodiment, reduced cost or free printing/copying/scanning/faxing is provided to corporate locations in exchange for accepting advertisement on one or more display devices associated with the print/copy/scan/fax system.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of an exemplary print/fax/scan/copy kiosk.

FIG. 2 illustrates a plan view of an exemplary print/fax/scan/copy kiosk.

FIG. 3 illustrates a first flow chart of the exemplary print/fax/scan/copy kiosk.

FIG. 4 illustrates a second flow chart of the exemplary print/fax/scan/copy kiosk.

FIG. 5 illustrates a schematic system view of the exemplary print/fax/scan/copy kiosk system.

FIG. 6 illustrates a first exemplary user interface of the print/fax/scan/copy kiosk.

FIG. 7 illustrates a second exemplary user interface of the print/fax/scan/copy kiosk.

FIG. 8 illustrates a plan view of an exemplary print/fax/scan/copy system with advertisement.

FIG. 9 illustrates a plan view of an exemplary print/fax/scan/copy system with advertisement.

FIG. 10 illustrates a first flow chart of the exemplary print/fax/scan/copy system with advertisement.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Described is one exemplary kiosk 10 for providing print/fax/scan/copy services under any of a variety of business models from free services, a hybrid limited free service and pay service, to a full pay-for-service model, with various way to compensate for real estate, power, maintenance, etc., as will be described in further detail.

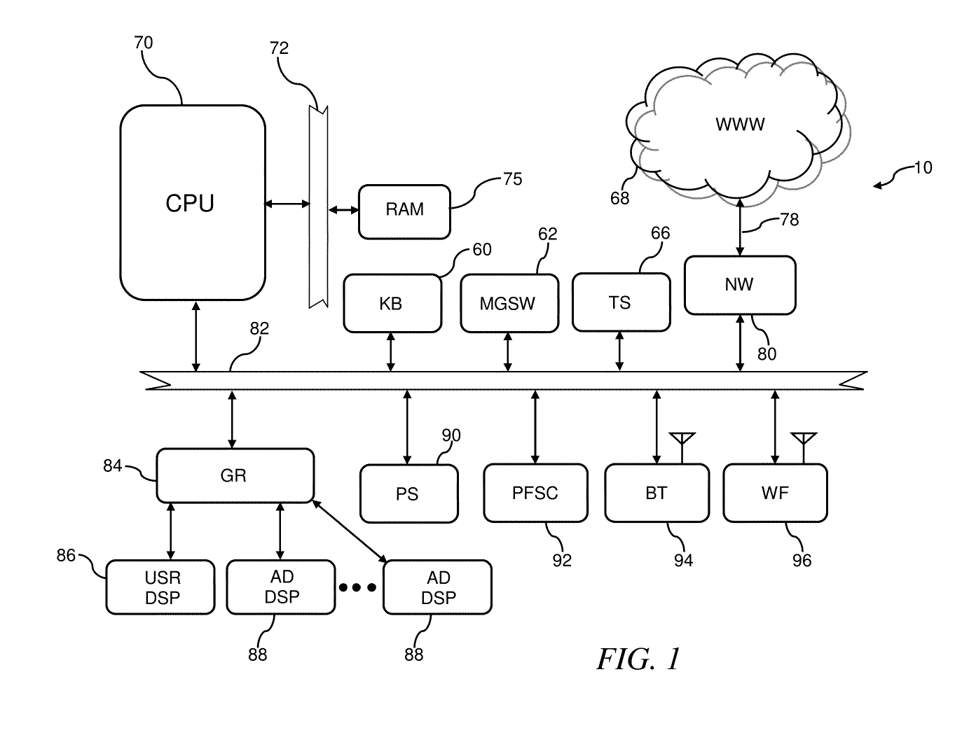

Referring to FIG. 1, a simplified schematic view of an exemplary print/scan/fax/copy kiosk 10 is shown. The exemplary print/scan/fax/copy kiosk 10 represents one typical configuration and is for explanatory purposes as many other configurations are anticipated. This exemplary print system or print/scan/fax/copy kiosk 10 is shown in its simplest form. Different architectures are known that accomplish similar results in a similar fashion and the present invention is not limited in any way to any particular print/scan/fax/copy kiosk 10, architecture, or implementation. It is fully anticipated that, in some embodiments, the print system performs less than all tasks (print, scan, fax, copy) such as print-only, print and receive faxes only, print and scan only, etc.

In this exemplary print/scan/fax/copy kiosk 10, a processor 70 executes or runs programs in a random access memory 75. The programs that control various aspects of the operation of the print/scan/fax/copy kiosk 10 are generally loaded into the random access memory 75 when needed. The processor 70 is any processor, suited for controlling the print/scan/fax/copy kiosk 10. The random access memory 75 is typically connected to the processor 70 by, for example, a memory bus 72. The random access memory 75 is any memory 75 suitable for connection and operation with the selected processor 70, such as SRAM, DRAM, SDRAM, RDRAM, DDR, DDR-2, etc.

Also connected to the processor 70 is a system bus 82 for connecting to peripheral subsystems such as a network interface 80 and a graphics adapter 84. The graphics adapter 84 receives commands from the processor 70 and controls what is depicted on, for example, one or more displays 86/88, including a user display 86 and one or more advertising displays 88 located proximal to the print/scan/fax/copy kiosk 10 or remotely from the print/scan/fax/copy kiosk 10, in some embodiments connected with wires and in some embodiments connected wirelessly.

In general, a persistent storage 90 stores control data, programs, etc., as known in the industry.

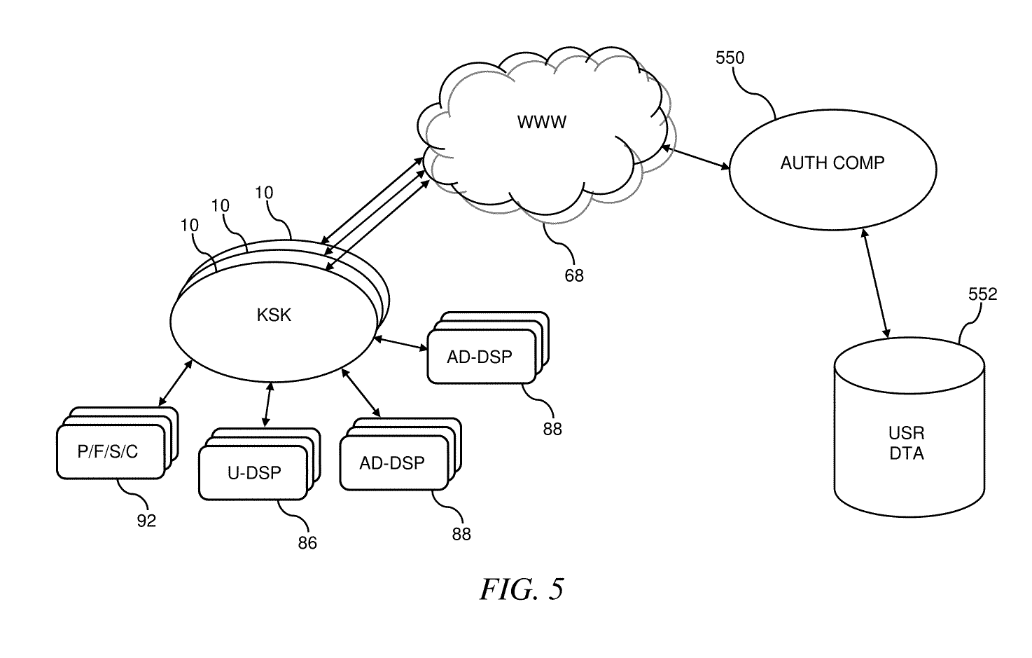

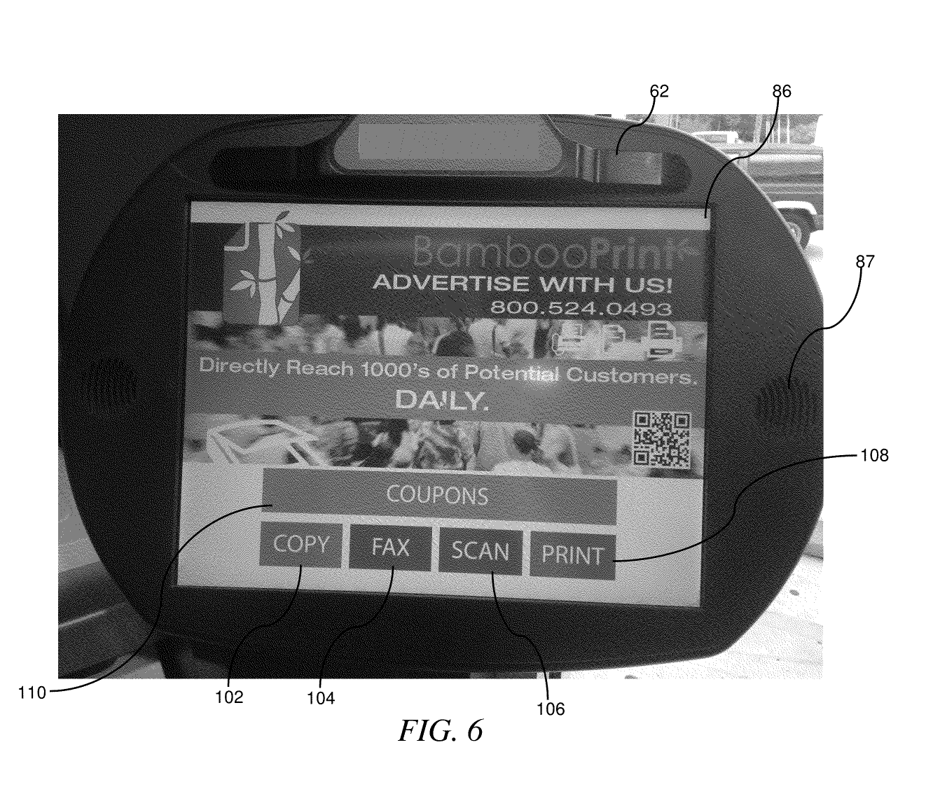

The peripherals shown are examples and other peripherals are known in the industry such as speakers 87 (see FIGS. 5 and 6), microphones, USB interfaces, Bluetooth transceivers 94, Wi-Fi transceivers 96, cameras, sensors, etc., the likes of which are not shown for brevity and clarity reasons.

In some embodiments, especially those having cameras, certain format photographic printing is performed using images from the camera and/or images from the user's active device (e.g. smartphone) or storage (e.g. flash drive). For example, in some embodiments, standard passport photographs are printed.

Although, in some embodiments, separate devices are present, in the embodiment shown, a combined printer/scanner/copier/fax device 92 is connected to the bus 82 and controlled by the processor 70. In some embodiments, a keyboard 60 is present, while in some embodiments, inputs are entered through a touch screen 66.

In some embodiments, a magnetic card swipe 62 is present for reading of a user's magnetic card or any other type of reader 62, including, but not limited to, smart-card readers, RFID readers, near-field readers, barcode scanners, etc. There are no limitations to the number and types of input devices interfaced to the processor 70 of the print/scan/fax/copy kiosk 10. In some embodiments, the magnetic card swipe 62 is used to accept payments for print/fax/scan/copy operations that are not free or to interface with point of service retailer loyalty programs, accepting and/or activating loyalty cards, etc.

The network adapter 80 is interfaced to the bus 82. The network adapter connects with any network 68 through any known connection means 78, including, but not limited to Wi-Fi, Ethernet, fiber optics, cable TV (COAX), satellite, T1, T3, etc.

User files are transferred to/from the user's device by any known interface including, but not limited to, direct connection through USB (e.g. a USB storage device or a USB connection to an active device such as a smartphone), through a wireless connection such as Wi-Fi 96 or Bluetooth 94, from removable storage such as a CD or DVD disk, from a computer-computer file transfer (e.g. FTP), from an attachment to an email, etc.

For printing or faxing, once the file is available to the print/fax/scan/copy kiosk 10 (e.g. stored in persistent storage 90), the user, after having been authorized, directs operations of the print/fax/scan/copy kiosk 10 to print or fax the file through, for example, the keyboard 60 or touchscreen 66.

For scanning or receiving faxes, after having been authorized, the user directs operations of the print/fax/scan/copy kiosk 10 to scan a document loaded in the printer's 92 tray through, for example, the keyboard 60 or touchscreen 66. The scanned or received file(s) are then transferred to the user's device by any known interface including direct connection through USB (e.g. a USB storage device or a USB connection to an active device such as a smartphone), through a wireless connection such as Wi-Fi 96 or Bluetooth 94, from removable storage such as a CD or DVD disk, from a computer-computer file transfer (e.g. FTP), from an attachment to an email, etc.

For copying, after having been authorized, the user directs operations of the print/fax/scan/copy kiosk 10 to copy (e.g. scan then print) a document loaded in the printer's 92 tray through, for example, the keyboard 60 or touchscreen 66.

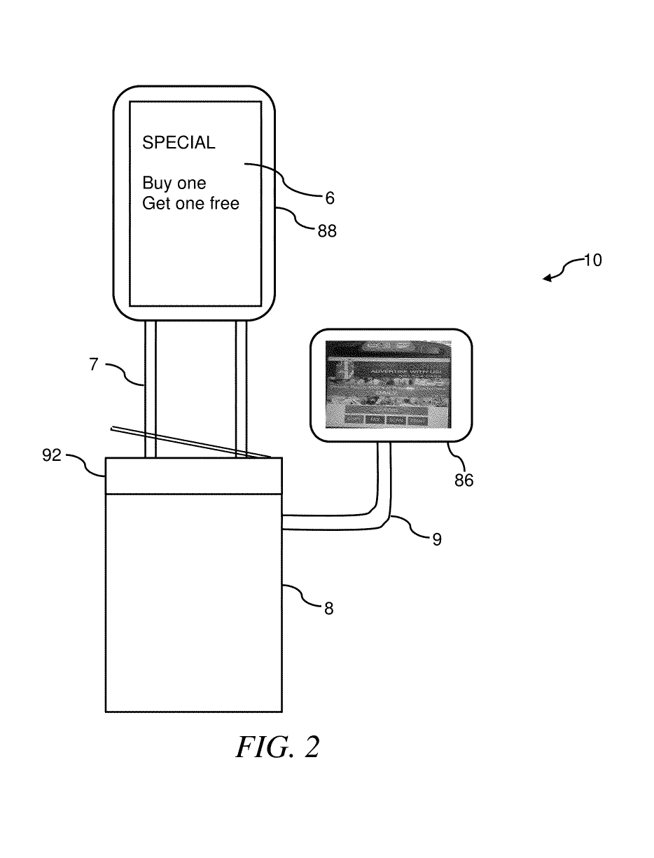

Referring to FIG. 2, a plan view of an exemplary print/fax/scan/copy kiosk 10 is shown. This view is of one possible physical embodiment of the print/fax/scan/copy kiosk 10, showing the advertisement display 88 mounted above a base unit 8 that houses the printer/fax/scanner/copier 92 with the control display 86 (and touch screen input) physically and electrically interfaced to the base 8 by an arm 9. The advertisement display shows an advertisement 6. In some embodiments, each advertisement 6 is downloaded from a server 550 (see FIG. 5), stored in persistent storage 90, and accessed when it is time for each advertisement 6 to be displayed. This provides for immediate updates to the advertisements 6 from a central site (server 500).

In this example, the advertisement display 88 is supported above the base 8 by supports 7, though in other embodiments, the advertisement display 88 is mounted in any known way, including direct mounting to other objects such as walls. As indicated, multiple advertisement displays 88 are equally anticipated. Again, this is only shown for example purposes.

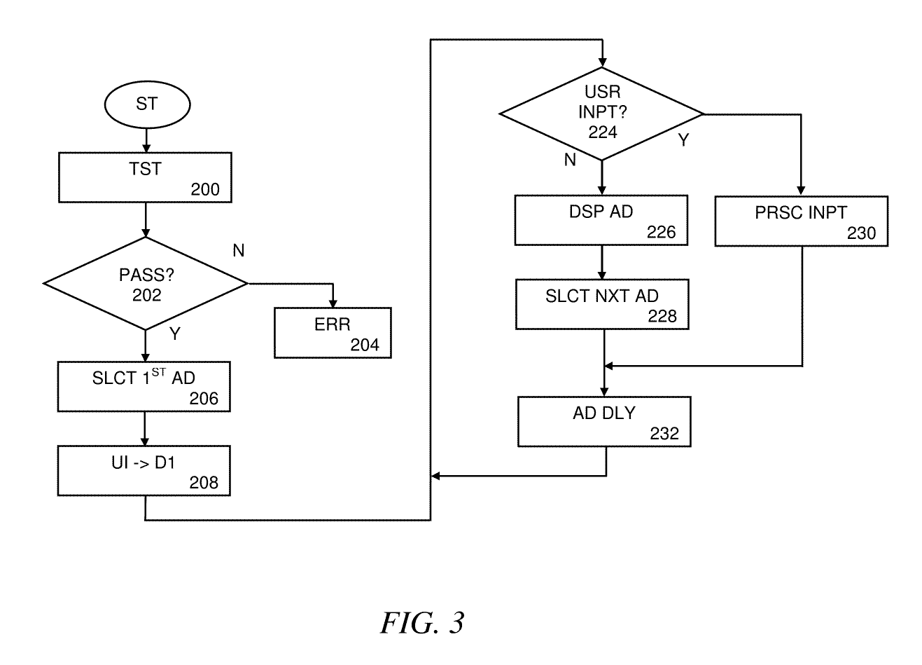

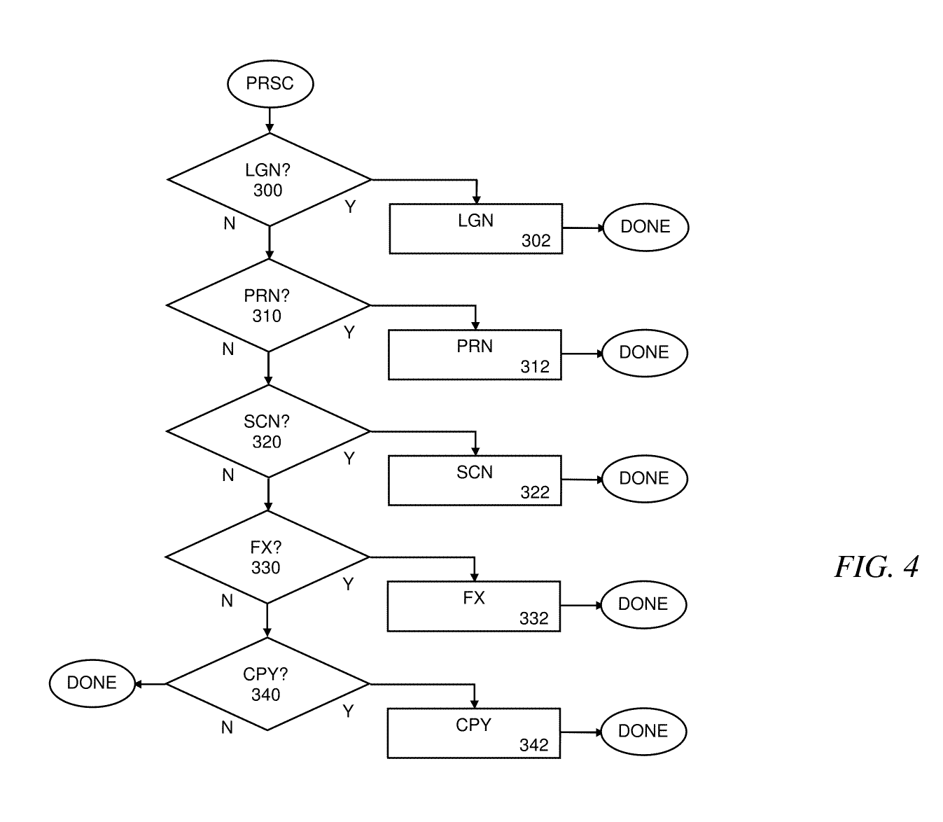

Referring to FIGS. 3 and 4, exemplary flow charts of the print/fax/scan/copy kiosk 10 are shown. Upon initialization, tests 200 are performed to determine if sufficient paper is available, sufficient ink/toner levels, proper connectivity to the various devices (e.g. printer 92, displays 86/88, etc.), and proper connectivity to the network 68 (e.g. Internet). If the tests do not pass 200, an error is reported 204 for example on one of the displays 86/88. Although not shown, it is fully anticipated that if any expendables run low (e.g., ink, toner, paper), a notification is transmitted to, for example, the server 550 indicating such. Responsive to the notification being received by the server 550, an action is taken by the server 550, including, but not limited to, automatically ordering replenishment supplies (e.g. more paper, new toner cartridge, new ink cartridge), notifying personnel to replenish supplies, schedule/dispatch a technician to replenish supplies, etc.

If the tests pass 202, a first advertisement is selected 206 and an initial user interface screen is presented 208 on the user display 86. Now a loop begins, each pass of the loop checks 224 to see if a user input has been made and, if a user input has been made, the input is processed 230 (see FIG. 4). If no user input has been made 224, the advertisement is displayed 226 and a next advertisement is selected 228. In either, a delay is taken 232 before the loop repeats and the new advertisement is displayed 226, providing sufficient time for the advertisement to be displayed on the advertisement display(s) 88. Note that this is but an exemplary program flow and many other flows are anticipated, including interrupt based flows in which the main program periodically updates the advertisements and when the keyboard 60 or touch screen 66 is operated, an interrupt to the main program flow processes the input, etc. Also, it is fully anticipated that, each advertisement include a display time and/or display period. For example, one advertiser requests (and pays for) a particular advertisement to be displayed twice every hour for 30 seconds each display and another advertiser requests (and pays for) another advertisement to be displayed at least five times each hour for 7 seconds each time, etc.

The flow continues in FIG. 4 with processing of the input. If the input is a logon 300, then the logon is processed 302 (e.g. the user enters their user name or email address and pin or password). If the input is a request to print 310 (user is already logged in), the user selects files that are to be printed and initiates the print operation 312.

If the input is a request to scan a document 320 (user is already logged in), the user places the document in the feed tray and requests the scan operation 322.

If the input is a request to fax a document 330 (user is already logged in), the user places the document in the feed tray and requests the fax operation 332.

If the input is a request to copy a document 340 (user is already logged in), the user places the document in the feed tray and requests the copy (scan/print) operation 342.

The above are exemplary operations and there are no limitations on the functionality provided through the user interface.

Referring to FIG. 5, a schematic system view of the exemplary print/fax/scan/copy kiosk 10 system is shown. In this, multiple print/fax/scan/copy kiosks 10 are shown, perhaps located in each convenience store of a particular retailer of gasoline. Each print/fax/scan/copy kiosk 10 has one or more advertisement displays 88, user interface displays 86 (and, for example, touch screens 66), and print/fax/scan/copy devices 92. Each print/fax/scan/copy kiosk 10 is connected to a server 550 through a network 68, for example, the world-wide-web (e.g. the Internet).

This server 550 along with secure user data 552 provides user authorization across the multitude of print/fax/scan/copy kiosks 10 such that each user has the ability to login and use some, any, or all print/fax/scan/copy kiosks 10. That being said, it is fully anticipated that there are groups of print/fax/scan/copy kiosks 10, and each group has its own user space. For example, one set of print/fax/scan/copy kiosks 10 are located in airports while another set of print/fax/scan/copy kiosks 10 are located in a certain brand of gas station convenience stores. In this, a user who is registered to use the print/fax/scan/copy kiosks 10 are located in airports while not necessarily being authorized to use the print/fax/scan/copy kiosks 10 located in the certain brand of gas station convenience stores. This creates the potential for branding the print/fax/scan/copy kiosks 10 within certain locations.

By providing print/fax/scan/copy kiosks 10 in airport locations, a traveler who is ready to get on a plane is able to print a small file for reading or send a last minute fax, etc. There are many locations where print/fax/scan/copy kiosks 10 will prove useful for users.

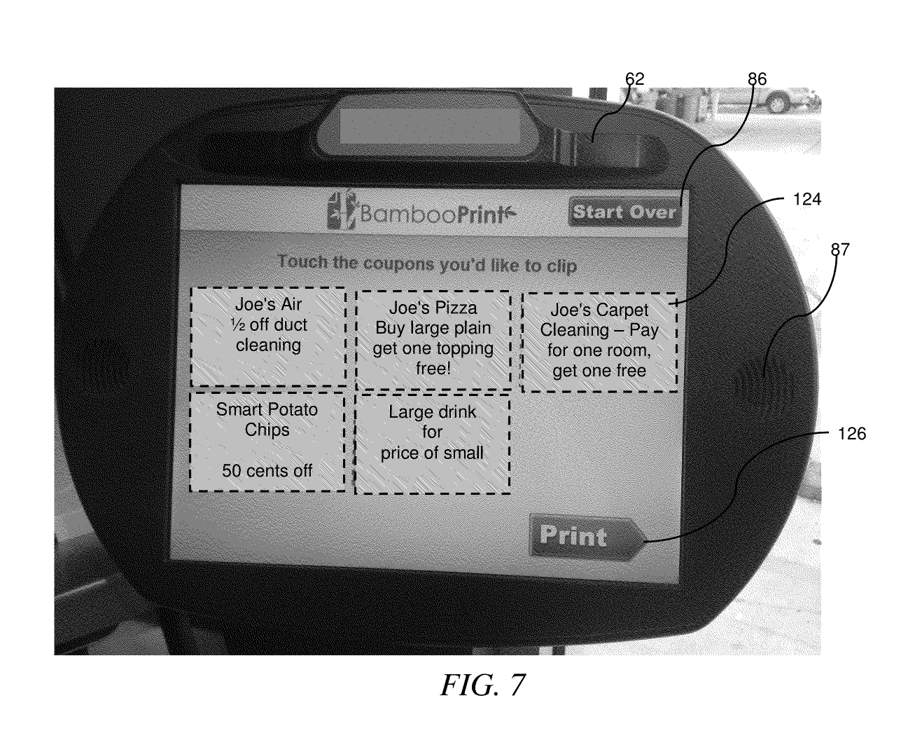

Referring to FIGS. 6 and 7, exemplary user interfaces of the print/fax/scan/copy kiosk 10 are shown. Although there are countless user interfaces anticipated, two brief user interface screens are shown as an example of the functionality possible with each print/fax/scan/copy kiosk 10. In the first figure, FIG. 6, an exemplary primary user interface is shown having activity buttons for initiating a copy 102, for initiating a fax 104, for initiating a scan 106, and for initiating a print operation 108.

One additional useful feature for the print/fax/scan/copy kiosk 10 is also shown in FIG. 6, which are generating/printing coupons 110. Being that the print/fax/scan/copy kiosk 10 is often located in a retail point of purchase (e.g. a convenience store), in some embodiments, advertisers offer the ability for the user (registered or not registered) to print coupons, for example as shown in FIG. 7. In this example, a coupon 124 is displayed and selected by the user, and then the print 126 function is executed, resulting in the coupon being printed such that the user takes the printed coupon to the store counter or to the retailer for redemption. In this example, the coupon 124 is for carpet cleaning and is likely to be redeemed when the user has the advertiser come to their home and clean some carpets, while some other coupons are for use directly in the point of purchase such as cents off for potato chips or special pricing for drinks.

Also shown in FIGS. 6 and 7 are exemplary card stripe readers 62 and a speaker 87. It is anticipated that one or more speakers 87, either associated with the user input panel or any of the advertisement displays 88, provide various features such as instructional messages, tones and music to gain attention, audio portions of the advertisements, etc.

Having the infrastructure of the print/fax/scan/copy kiosk 10 provides for several variations of business opportunities. It is already well known that users are willing to pay a small price per page for printing, scanning, copying, and/or faxing. This business model has been practiced for many years with respect to copy centers, print centers, printing of digital photographs, etc. One aspect of the prior infrastructure is location—the size of these operations requires significant office/store square footage. For copy centers, often the entire store is dedicated to this function. For photographic printing, often an large area within a store (e.g. drugstore) is dedicated to printing photographs. In both scenarios, either dedicated or shared personnel are required to operate the equipment, though for printing photographs, often the user performs most steps up until the photographs are placed in an envelope and the payment transaction is performed.

As discussed previously, to avail oneself of such print/fax/scan/copy services, one must often make a special trip to seek such service, perhaps several miles out of the way, costing time and energy. In one scenario of the disclosed invention, the print/fax/scan/copy kiosk 10 is highly distributed in locations often frequented by most individuals. For example, by locating a print/fax/scan/copy kiosk 10 in every convenience store of a particular brand of gasoline, each time a person purchases fuel, that person is within a few feet of the print/fax/scan/copy kiosk 10. Therefore, when a person needs to print/fax/scan/copy, they need only plan to do such at the same time they are refueling their vehicle which, for many, is at least weekly. Even without the need for fuel, such convenience stores are often well distributed around communities.

With the current state of refueling, many never leave the vicinity of their vehicle, paying for fuel at the pump with their credit cards. This results in less traffic into the convenience stores and lower income to the overall operation. In the fuel industry, there is often only a small profit to be made on fuel, often subsidized greatly by the sale of items within the convenience store associated with the gas station. Any increase of traffic into the convenience store is potentially an increase of sales as it is well known that humans often impulse buy. Seeing a cold ice slush advertisement on a hot day often makes one thirsty enough to buy one. Therefore, if a few more people enter the convenience store for the purpose of print/fax/scan/copy, some of those people are likely to make other purchases.

There is a cost associated with the print/fax/scan/copy kiosk 10 that must be accrued and balanced within the profit/loss calculations of such businesses. It is difficult to justify the cost of a print/fax/scan/copy kiosk 10 by increased patronage of the convenience store alone, as it is difficult to measure an increase in sales attributed to the increased patronage, though such a measurement is possible. Therefore, another way to balance the cost of the print/fax/scan/copy kiosk 10 is through other income sources such as advertising. The print/fax/scan/copy kiosk 10, as described above, has an associated advertisement display 88 (or multiple advertisement displays 88). As people enter, for example, the convenience store to print/fax/scan/copy, those people (as well as other casual observers) will notice advertisements on the advertisement displays 88, especially being that it takes time to print/fax/scan/copy; time for the user to be exposed to several advertisements. These advertisements are likely to be much more effective than, for example, external signage or billboards, because the products being advertised are directly available at the site where the advertisement is made—for example, in the convenience store. For example, if a certain convenience store typically sells around 99 cases of beer per week and had three brands of beer having equal shares of these sales (33 cases each), if one of the three beer brands advertises with the print/fax/scan/copy kiosk 10, that brand's share is likely to increase. Even a small increase to, say 34 cases per week, has huge profit ramifications when extrapolated to several thousand convenience stores.

It is important to ubiquitously locate the print/fax/scan/copy kiosk 10, so the users come to know where they are and come to expect the usefulness, quality, availability and features and, therefore, lessen the user's need to have a home print/fax/scan/copy device. To provide incentive for users to move away from home print/fax/scan/copy devices and make more use of the print/fax/scan/copy kiosk 10, one business model includes providing a predetermined number of operations for free per time period. Each user signs up with the service, providing the user's email address as a way to contact the user and to validate, to some extent, that each user has a single account, being that most users have only one email account. As such, in an exemplary embodiment, the user registers with the service then receives an email to complete the registration, which requires a unique code for the user to complete registrations. Then, when the user needs to print/fax/scan/copy, the user enters their email (or user id) and password at the print/fax/scan/copy kiosk 10, and the system authorizes that user for the agreed number of free operations (prints/faxes/scans/copies). For example, in one scenario, each user is allowed free printing and/or copying of 15 pages per month, free scanning of 50 pages per month, and free faxing of 5 pages per month. It is also anticipated that, through the logon process, the user is capable of receiving faxes for printing at the print/fax/scan/copy kiosk 10.

By limiting each user to a certain number of operations per time period, it makes it difficult for user's to take advantage of the system by signing up for multiple accounts, being that having multiple accounts will require the user to preform many small operations and take larger amounts of time at the print/fax/scan/copy kiosk 10, though this is often difficult to prevent. To allow for users who periodically need additional services, above what is provided for free, in some embodiments, users, either at the print/fax/scan/copy kiosk 10 or during registration, provide a form of payment such as a credit card or other electronic payment, and that user is allowed to print/fax/scan/copy beyond the above stated limit at a cost that is charged to their form of payment(s). For example, if the user is allowed 15 pages of paper per month (print, copy, received fax) but they need to print 40 pages, the first 15 pages are free and the next 25 pages cost 10 cents per page ($2.50).

It is also anticipated that each user have a maximum usage per day so as to not be able to tie up the print/fax/scan/copy kiosk 10 for extended periods of time.

In some business models, profit is made by the owner of the print/fax/scan/copy kiosk 10 through advertising alone. In some business models, profit is made by the owner of the print/fax/scan/copy kiosk 10 through advertising and through sales of the services such as per-page printing/faxing/copying/scanning. In some business models, the owner of the print/fax/scan/copy kiosk 10 remunerates the point of location (e.g. the convenience store) a fixed fee for providing the space, power, and service (e.g. replacing toner, adding paper). In some business models, the owner of the print/fax/scan/copy kiosk 10 remunerates the point of location (e.g. the convenience store) a percentage of the advertising profits for providing the space, power, and service (e.g. replacing toner, adding paper). In some business models, the point of location owner outright purchases or leases the print/fax/scan/copy kiosk 10, maintaining all profits for advertising, etc. In some business models, the point of location owner outright purchases or leases the print/fax/scan/copy kiosk 10, sharing some of the profits from advertising, etc. with the provider of the print/fax/scan/copy kiosk 10, while maintaining most of the profits. In some business models, the printer/fax/scanner/copier 92 is a corporate type of printer/fax/scanner/copier 92 and is sold or leased to a business at a reduced rate and the provider of the printer/fax/scanner/copier 92 profits from advertisements and/or clients activity in response to such advertisements (e.g., placing an order). In some business models, the printer/fax/scanner/copier 92 is a corporate type of printer/fax/scanner/copier 92 and is sold or leased to a business along with the advertising capabilities and the buying/leasing corporation controls/provides the advertisements and/or profits from clients activity in response to such advertisements (e.g., placing an order).

In some embodiments, further remuneration is provided when a coupon 124 is either printed or redeemed. One example with a coupon, each printing of a coupon is recorded for later payment from the advertiser to the kiosk 10 owner and/or retailer at point-of-use. Another example with the carpet cleaning coupon is a code is printed on the coupon (either human readable or scannable as in a bar code) and, when the user redeems that coupon, the code is reported for proper compensation from the coupon provider back to the kiosk 10 owner and/or retailer at point-of-use.

Although, the above description shows the print/fax/scan/copy kiosk 10 located in a convenience store associated with a gas station, there is no limitation on location and any suitable location is anticipated such as a convenience store that is not associated with a gas station, hotels, restaurants, malls, airports, grocery stores, office buildings, etc.

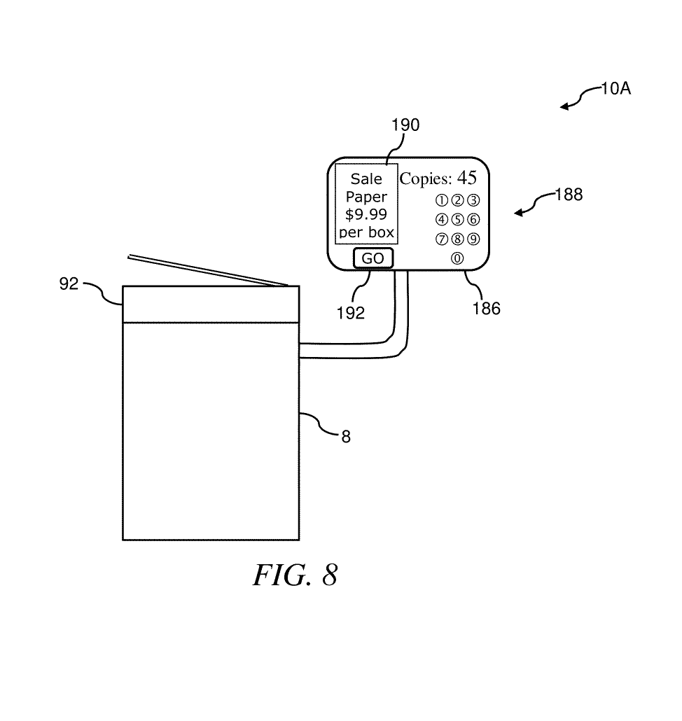

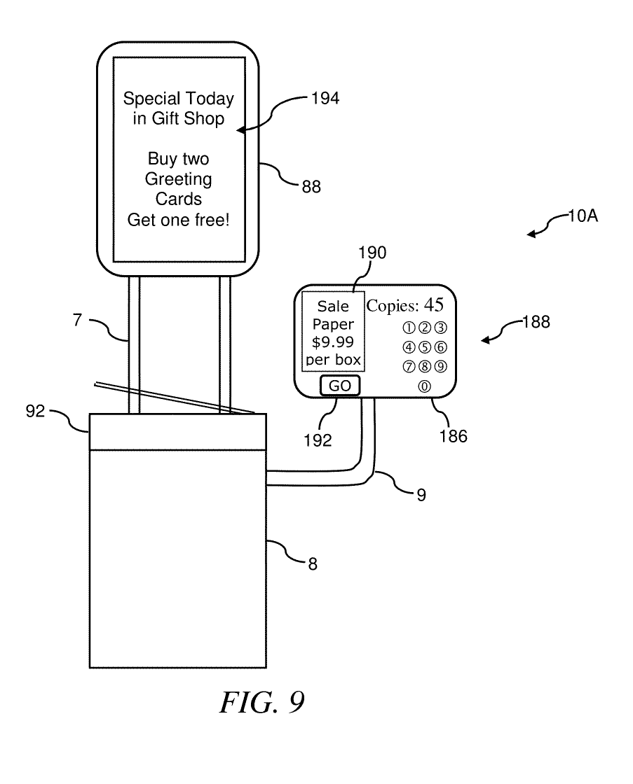

Referring to FIGS. 8 and 9, plan views of an exemplary print/fax/scan/copy system 10A with advertisement are shown. These views show anticipated physical embodiments of the print/fax/scan/copy kiosk 10A. In FIG. 8, an advertisement 194 is displayed on a control display 186 while in FIG. 9, a second advertisement 190 is displayed on a control display 186 while optionally another (same or different) advertisement is displayed on an advertisement display 88 mounted above a base unit 8 that houses the printer/fax/scanner/copier 92. In the example shown, the control/display 186 (e.g., display with touch screen input) physically and electrically interfaces to the base 8, for example, by an arm 9, while it is understood that any location and support mechanism is anticipated such as integrated/connected to the printer/fax/scan/copy device 92 in any way known in the business. In FIG. 9, the advertisement display 88 shows an advertisement 194.

In some embodiments, each advertisement 194 is downloaded from a server 550 (see FIG. 5), stored in persistent storage 90, and accessed when it is time for each advertisement 194 to be displayed. This provides for immediate updates to the advertisements 194 from a central site (server 500). In some embodiments, a second advertisement 190 is displayed on the control display 186. In some such embodiments, the second advertisement 190 includes a select feature 192 (e.g., “Go”), that, for example using the touch input of the control display 186, instructs the print/fax/scan/copy system 10A to take action related to the advertisement 194 and/or the second advertisement 190. For example, if the advertisement 194 and/or the second advertisement 190 includes a coupon, then activating the select feature 192 on the printer/fax/scan/copy device 92. In another example, activation of the select feature 192 changes the mode of the control display 186 to another view such as further information regarding the offer and how to obtain the offer, an ordering and check-out menu, a redirection to a web page for details and ordering, etc.

In the example of FIG. 9, the advertisement display 88 is supported above the base 8 by supports 7, though in other embodiments, the advertisement display 88 is mounted in any known way, including direct mounting to other objects such as walls. As indicated, multiple advertisement displays 88 are equally anticipated.

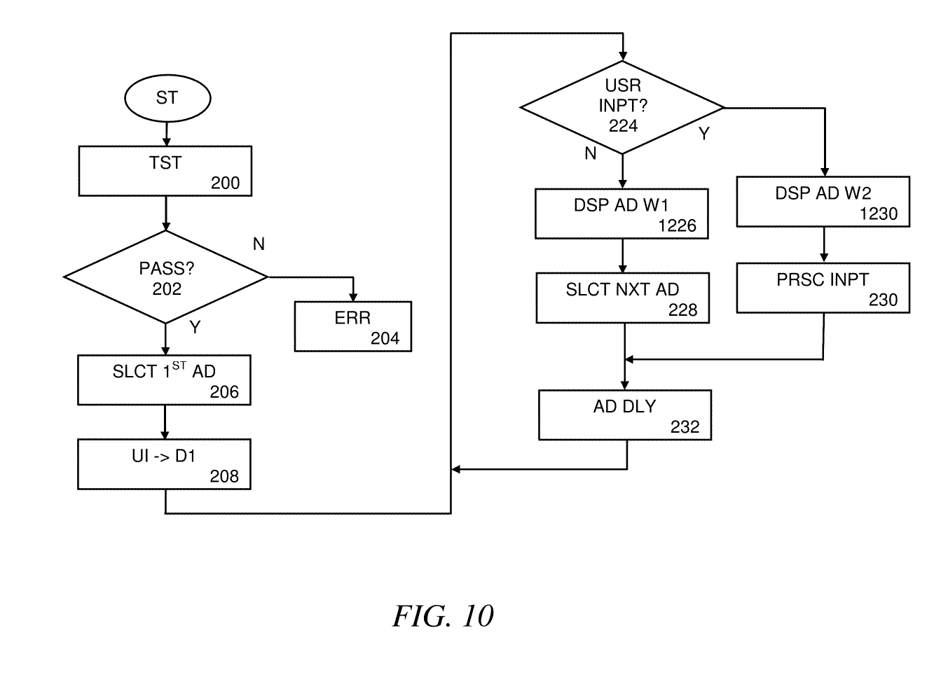

Referring to FIG. 10, a first flow chart of the exemplary print/fax/scan/copy system with advertisement is shown. In a similar flow as shown in FIG. 3, upon initialization, tests 200 are performed to determine if sufficient paper is available, sufficient ink/toner levels, proper connectivity to the various devices (e.g. printer 92, displays 86/88, etc.), and proper connectivity to the network 68 (e.g. Internet). If the tests do not pass 200, an error is reported 204 for example on one of the displays 86/88. Although not shown, it is fully anticipated that if any expendables run low (e.g., ink, toner, paper), a notification is transmitted to, for example, the server 550 indicating such. Responsive to the notification being received by the server 550, an action is taken by the server 550, including, but not limited to, automatically ordering replenishment supplies (e.g. more paper, new toner cartridge, new ink cartridge), notifying personnel to replenish supplies, schedule/dispatch a technician to replenish supplies, etc.

If the tests pass 202, a first advertisement is selected 206 and an initial user interface screen is presented 208 on the user display 186. Now a loop begins, each pass of the loop checks 224 to see if a user input has been made and, if a user input has been made, in some embodiments, the second advertisement 190 is displayed 1230 on the user display 186 then the input is processed 1230 (see FIG. 4). If no user input has been made 224, in systems with the advertisement display(s) 88, the advertisement 194 is displayed 226 on the advertisement display(s) 88 and a next advertisement is selected 228. In either, a delay is taken 232 before the loop repeats and the new advertisement is displayed 226, providing sufficient time for the advertisement 194 to be displayed on the advertisement display(s) 88. Note that this is but an exemplary program flow and many other flows are anticipated, including interrupt based flows in which the main program periodically updates the advertisements and when the keyboard 60 or touch screen 66 is operated, an interrupt to the main program flow processes the input, etc. Also, it is fully anticipated that, each advertisement include a display time and/or display period. For example, one advertiser requests (and pays for) a particular advertisement to be displayed twice every hour for 30 seconds and another advertiser requests (and pays for) another advertisement to be displayed at least five times each hour for 7 seconds each time, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A print/fax/scan/copy system comprising:
a housing;
a computer within the housing;
a print device operably coupled to the computer, the print device interfaced to the housing;
a user input/output device operably coupled to the computer for accepting user inputs and for displaying selections and prompts;
at least one advertisement display device operable coupled to the computer and co-located with the kiosk housing;
a plurality of advertisements accessible by the computer;
means for entering a print job coupled to the computer;
means for printing the print job at the print device; and
means for selecting an advertisement from the plurality of advertisements and displaying the advertisement on one of the at least one advertisement displays while providing print services.

2. The print/fax/scan/copy system of claim 1, wherein the print device includes scanning, copying, and faxing capabilities.

3. The print/fax/scan/copy system of claim 1, wherein income is derived from advertisers sponsoring the plurality of advertisements.

4. The print/fax/scan/copy system of claim 1, wherein no money is required for using the means for entering the print job and the means for printing the print job.

5. The print/fax/scan/copy system of claim 1, wherein the means for entering the print job comprises transmission of the print job from a portable computing device to the computer through a wireless connection.

6. The print/fax/scan/copy system of claim 1, wherein the means for entering the print job comprises transmission of the print job from a cell phone to the computer through a wireless Bluetooth connection.

7. The print/fax/scan/copy system of claim 1, wherein the means for entering the print job comprises transmission of the print job from a portable computing device to the computer through a Universal Serial Bus connection.

8. A system comprising:
a housing;
a computer within the housing;
a print device operably coupled to the computer, the print device interfaced to the housing, and the print device having printing and scanning functionality;
a user input/output device operably coupled to the computer for accepting user inputs and for displaying selections and prompts on a display;
a plurality of advertisements accessible by the computer;
a communications port for entering files into the computer, the communication port operatively interfaced to the computer; and
software running on the computer, the software selecting an advertisement from the plurality of advertisements and displaying the advertisement on the display of the user input/output device.

9. The system of claim 8, further comprising a second communications port for removing the files from the computer, the second communications port operatively interfaced to the computer.

10. The system of claim 9, wherein after receiving an incoming fax from a network connection, the computer forwards the incoming fax to a device connected to the second communications port.

11. The system of claim 10, wherein after receiving a file from the communications port, the computer sends the file to a remote fax device through the network connection.

12. The system of claim 8, whereas after receiving a print file from the communications port, the software instructs the print device to print the print file on paper.

13. The system of claim 8, wherein the communications port is a wireless Bluetooth connection.

14. The system of claim 8, wherein the communications port is Universal Serial Bus connection.

15. A system comprising:
a housing;
a computer within the housing;
a print device operably coupled to the computer, the print device interfaced to the housing;
a user input/output device operably coupled to the computer for accepting user inputs and for displaying selections and prompts on a display;
a plurality of advertisements accessible by the computer;
a communications port for entering files into the computer, the communication port operatively interfaced to the computer; and
software running on the computer, the software selecting an advertisement from the plurality of advertisements and displaying the advertisement on the display of the user input/output device.

16. The system of claim 15, whereas after receiving a print file from the communications port, the software instructs the print device to print the print file on paper and during the time that the print device is printing the print file, the software displays a selected advertisement on the display of the user input/output device.

17. The system of claim 16, wherein the communications port is a wireless Bluetooth connection.

18. The system of claim 17, wherein the print job is transferred from a portable device to the computer over the wireless Bluetooth connection.

19. The system of claim 16, wherein the communications port is Universal Serial Bus connection.

20. The system of claim 17, wherein the print job is transferred from a portable device to the computer over the Universal Serial Bus connection.
